(19) United States
(12) Patent Application Publication
(10) Pub. No.: US 2023/0318342 A1
(43) Pub. Date: Oct. 5, 2023

(54) Method for Controlling Charging of an Electronic Device

(71) Applicant: Google LLC, Mountain View, CA (US)

(72) Inventors: Lei Yu, San Diego, CA (US); Ajmal Godil, San Diego, CA (US); Conrad Smith, San Diego, CA (US); David Boyd Townsley, San Francisco, CA (US)

(21) Appl. No.: 17/710,125

(22) Filed: Mar. 31, 2022

(51) Int. Cl. H02J 7/00

(52) U.S. Cl. CPC H02J 7/00714; H02J 7/007182

(57) ABSTRACT

A method for controlling charging of a wearable computing device includes determining a voltage at a charging interface of the wearable computing device when the wearable computing device is not being charged by an external power supply to which the wearable computing device is coupled via a conductor. The method includes determining a resistance of the conductor when the wearable computing device is drawing a first charging current from the external power supply. The method includes determining an expected voltage drop between the external power supply and the wearable computing device when the wearable computing device is drawing a second charging current that is greater than the first charging current. The method includes reducing the current draw when an actual voltage drop between the external power supply and the wearable computing device is greater than a threshold voltage drop that is greater than the expected voltage drop.

### FIELD

The present disclosure relates generally to electronic devices having an energy storage device (e.g., rechargeable battery). More particularly, the present disclosure relates to a method for controlling charging of the energy storage device.

### BACKGROUND

Electronic devices (e.g., smartphones, smartwatches, laptops, tablets, etc.) can include a rechargeable battery that provides direct current power to electronic components thereof. For instance, the rechargeable battery can be disposed within a housing of the electronic devices. Furthermore, the electronic devices can include a charging interface (e.g., charging port) to facilitate coupling the rechargeable battery to an external power supply (e.g., wall outlet) via a charging cable. In this manner, the electronic device can draw a charging current from the external power supply to charge the rechargeable battery.

### SUMMARY

Aspects and advantages of embodiments of the present disclosure will be set forth in part in the following description, or can be learned from the description, or can be learned through practice of the embodiments.

In one aspect, a method for controlling charging of a wearable computing device is provided. The method includes determining, via a power management circuit of the wearable computing device, a voltage at a charging interface of the wearable computing device when the wearable computing device is not being charged by an external power supply that is coupled to the charging interface via a conductor. In response to determining the voltage, the method includes causing, via the power management circuit, the wearable computing device to draw a first charging current from the external power supply. The method includes determining, via the power management circuit, a resistance of the conductor based, at least in part, on the first charging current. The method includes determining, via the power management circuit, an expected voltage drop between the external power supply and the wearable computing device when the wearable computing device is drawing the second charging current. More specifically, the expected voltage drop can be determined based on the determined resistance of the conductor. The method further includes determining whether an actual voltage drop between the external power supply and the wearable computing device when the wearable computing device is drawing a charging current is greater than a threshold voltage drop. More specifically, the threshold voltage drop is greater than expected voltage drop. Furthermore, in response to determining the actual voltage drop is greater than the threshold voltage drop, the method includes reducing, via the power management circuit, the current draw of the wearable computing device.

In another aspect, a wearable computing device is provided. The wearable computing device includes an energy storage device and a charging interface. The wearable computing device further includes a power management circuit electrically coupling the charging interface to the energy storage device. The power management circuit is configured to determine a voltage at the charging interface when the wearable computing device is not being charged by an external power supply that is coupled to the charging interface via a conductor. In response to determining the voltage, the power management circuit is configured to draw a first charging current from the external power supply. The power management circuit is configured to determine a resistance of the conductor based, at least in part, on the first charging current. The power management circuit is configured to determine an expected voltage drop between the external power supply and the wearable computing device when the wearable computing device is drawing the second charging current. More specifically, the expected voltage drop can be determined based on the determined resistance of the conductor. The power management circuit is configured to determine whether an actual voltage drop between the external power supply and the wearable computing device when the wearable computing device is drawing a charging current is greater than a threshold voltage drop. More specifically, the threshold voltage drop is greater than expected voltage drop. Furthermore, in response to determining the actual voltage drop is greater than the threshold voltage drop, the power management circuit is configured to reduce the current draw of the wearable computing device.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an external power supply coupled to a wearable computing device according to example embodiments of the present disclosure.

FIG. 2 depicts a flow diagram of a method for controlling charging of an electronic device according to some implementations of the present disclosure.

block diagram of components of a charging assembly for charging a rechargeable battery of a wearable computing device according to some implementations of the present disclosure.

FIG. 3 depicts a perspective view of a wearable computing device according to some implementations of the present disclosure.

FIG. 4 depicts a cross-sectional view of a wearable computing device according to some implementations of the present disclosure.

FIG. 5 depicts a bottom perspective view of the wearable computing device of FIG. 3 according to some implementations of the present disclosure.

FIG. 6 depicts a block diagram of components of a computing system of a wearable computing device according to some implementations of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to electronic devices having an energy storage device (e.g., rechargeable battery) that provides direct current power to various electronics (e.g., sensors, processors, display, etc.) thereof. For example, an electronic device according to the present disclosure can include a wearable computing device capable of being worn, for instance, on the arm of a user. The wearable computing device can include a charging interface capable of being coupled to an external power supply (e.g., wall charger) via a conductor (e.g., charging cable). In this manner, the wearable computing device can draw a charging current from the external power supply to charge the energy storage device thereof.

The wearable computing device can include a power management circuit configured to control charging of the energy storage device. For instance, the power management circuit can compare a voltage at the charging interface to a predefined threshold voltage drop between the external power supply and the wearable computing device to determine whether the external power supply is at risk of collapsing (e.g., tripping circuit breaker). When the voltage at the charging interface is greater than the predefined threshold voltage, the power management circuit can reduce a charging current the wearable computing device draws from the external power supply. It should be understood that an expected voltage drop between the external power supply and the wearable computing device is determined based, at least in part, on the charging current and a resistance of the conductor (e.g., charging cable). However, since the pre-defined threshold voltage drop is not based on the expected voltage drop, instances can occur in which the pre-defined threshold voltage drop is less than the expected voltage drop. Furthermore, reducing the charging current in such instances would be premature and would cause the wearable computing device to be charged at a slower speed (e.g., charging current) than necessary.

Example aspects of the present disclosure are directed to a method for controlling charging of the wearable computing device. For instance, the power management circuit can be configured to determine a voltage at the charging interface when the wearable computing device is coupled to the external power supply but not drawing a charging current therefrom. In this manner, the power management circuit can determine or estimate a voltage at the external power supply since a voltage drop between the external supply and the wearable computing device is negligible when the wearable computing device is not drawing a charging current from the external power supply. After determining the voltage at the charging interface, the power management circuit can cause the wearable computing device to draw a charging current from the external power supply. For instance, the power management circuit can be configured to cause the wearable computing device to draw a first charging current (e.g., about 100 milliamps). The power management circuit can determine a resistance of the conductor (e.g., charging cable) based, at least in part, on the first charging current. After determining the resistance of the conductor, the power management circuit can increase the charging current from the first charging current to a second charging current (e.g., about 500 milliamps).

The power management circuit can be configured to determine an expected voltage drop between the external power supply and the wearable computing device when the wearable computing device is drawing the second charging current. It should be understood that the expected voltage drop is determined based on the second charging current and the determined resistance of the conductor. The power management circuit can then be configured to monitor an actual voltage drop between the external power supply and the wearable computing device when the wearable computing device is drawing a charging current (e.g., second charging current) from the external power supply. For instance, the power management can be configured to obtain the voltage at the charging interface after the passage of a predetermined amount of time and can compare the voltage at the charging interface to a threshold voltage drop that is greater than the expected voltage drop. In some implementations, the threshold voltage drop can be at least about 100 millivolts greater than the expected voltage drop. For example, in some implementations, the expected voltage drop can be 4.7 Volts and the threshold voltage drop can be 4.5 Volts. As used herein, use of the term “about” in conjunction with a stated numerical value refers to a range of values within 10 percent of the stated numerical value.

When the power management circuit determines the actual voltage drop is greater than the threshold voltage drop, the power management circuit can determine the external power supply is at risk of collapsing and can reduce the charging current accordingly. For instance, in some implementations, the power management circuit can be configured to reduce the charging current from the second electrical current to the first electrical current. In this manner, the power management circuit of the wearable computing device can protect the external power supply from collapsing. For example, the power management circuit can reduce the current draw of the wearable computing device as needed to prevent the wearable computing device from tripping a circuit breaker associated with the external power supply.

Wearable computing devices according to example aspects of the present disclosure can provide numerous technical effects and benefits. For instance, wearable computing devices according to the present disclosure can protect the external power supply from collapsing since the power management circuit determines the threshold voltage drop based on the expected voltage drop between the external power supply and the wearable computing device when drawing the second charging current. Furthermore, since the threshold voltage drop is set to be greater than the expected voltage drop, instances can be avoided in which the power management circuit improperly reduces the charging current when the actual voltage drop between the external power supply and the wearable computing device corresponds to the expected voltage.

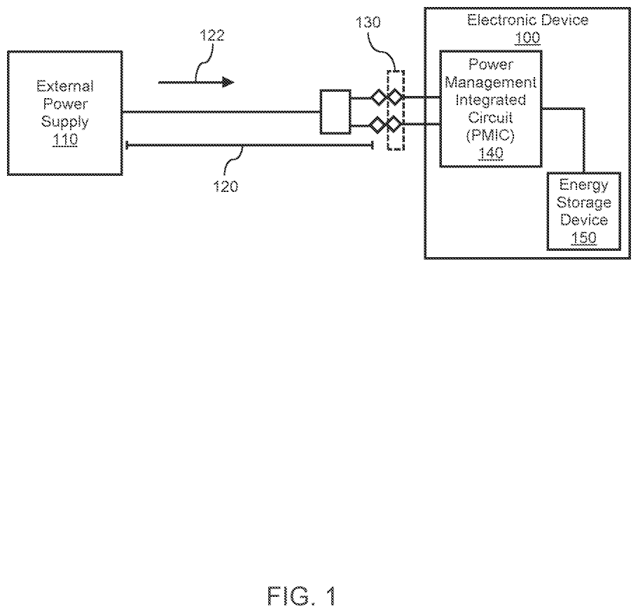

Referring now to the FIGS., FIG. 1 depicts an electronic device 100 coupled to an external power supply 110 via a conductor 120. In some implementations, the external power supply 110 can be an alternating current (AC) wall outlet. In alternative implementations, the external power supply 110 can include another electronic device (e.g., laptop) configured to output direct current (DC) power.

It should be understood that the conductor 120 can provide an electrical path from the external power supply 110 (e.g., an alternating current wall outlet e.g., about a 120V AC wall outlet, USB charging source, or other suitable power source) to the electronic device 100. In this manner, the electronic device 100 can draw a charging current 122 from the external power supply 110. In some implementations, the conductor 120 can include a charging cable. For instance, in some implementations, the charging cable can include a universal serial bus (USB) charging cable. It should be understood, however, that the charging cable can include any suitable type of charging cable.

The electronic device 100 can include a charging interface 130. The charging interface 130 can couple the electronic device 100 to an end of the conductor 120. In some implementations, the charging interface 130 can include a plurality of charging pins that can each electrically couple to a corresponding contact of the conductor 120. In alternative implementations, the charging interface 130 can include a charging port into which the end of the conductor 120 is inserted. Other suitable charging interfaces can be used without deviating from the scope of the present disclosure, including wired and/or wireless (e.g., contact based) charging interfaces.

The electronic device 100 can include a power management circuit 140. The power management circuit 140 can be electrically coupled between the charging interface 130 and an energy storage device 150 of the electronic device 100. In some implementations, the energy storage device 150 can include a rechargeable battery. As will be discussed below in more detail, the power management circuit 140 can be configured to control charging of the energy storage device 150 via the external power supply 110.

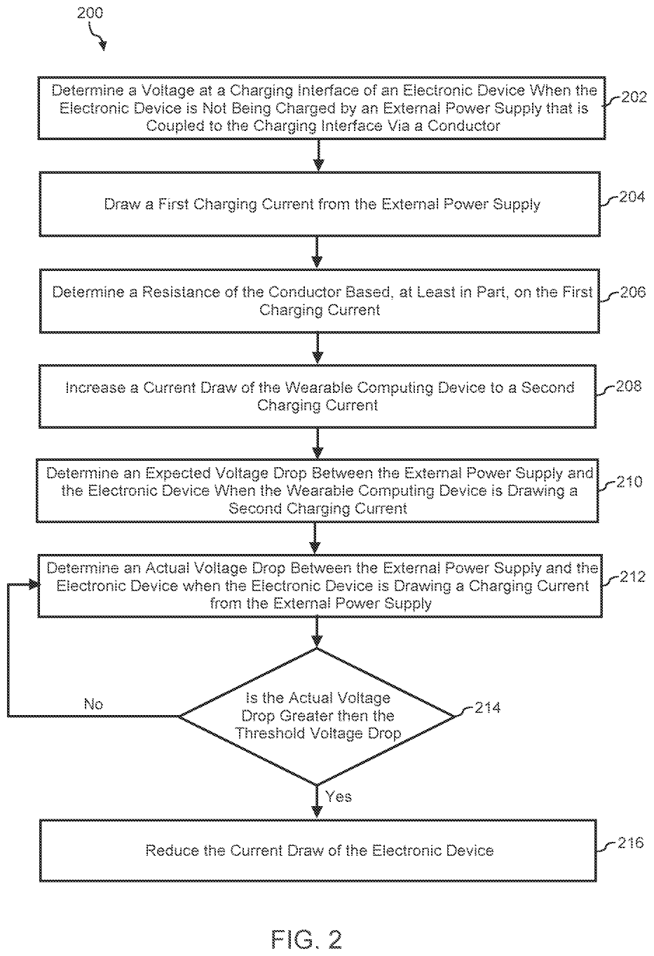

Referring now to FIG. 2, a flow diagram of an example method 200 of controlling charging of an electronic device is provided according to implementations of the present disclosure. The method 200 can be implemented by, for instance, the power management circuit 140 of the electronic device 100 discussed above with reference to FIG. 1. FIG. 2 depicts steps performed in a particular order for purposes of illustration and discussion. Those of ordinary skill in the art, using the disclosures provided herein, will understand that various steps of the method 200 or any of the other methods disclosed herein may be adapted, modified, rearranged, performed simultaneously, or modified in various ways without deviating from the scope of the present disclosure.

At (202), the method 200 can include determining, via the power management circuit, a voltage at a charging interface of the electronic device when the electronic device is coupled to the external power supply via a conductor but is not drawing a charging current from the external power supply. It should be understood that a voltage drop between the external power supply and the electronic device is negligible when the electronic device is not drawing a charging current. In this manner, the voltage at the charging interface when the electronic device is not drawing a charging current can be indicative of a voltage of the external power supply.

At (204), the method 200 can include drawing, via the power management circuit, a first charging current from the external power supply 110. In some implementations, the first charging current can range about 100 milliamps to about 300 milliamps.

At (206), the method 200 can include determining a resistance of the conductor based, at least in part, on the first charging current, the voltage at the charging interface when the electronic device is not drawing a charging current as determined at (202), and a voltage at the charging interface when the electronic device is drawing the first charging current. It should be understood that a difference between the voltage at the charging interface when drawing no charging current and the voltage at the charging interface when drawing the first charging current can be divided by the first charging current to obtain the resistance of the conductor. In some implementations, the resistance of the conductor (e.g., charging cable) can range from about 5 ohms to about 20 ohms.

At (208), the method 200 can include increasing, via the power management circuit, the charging current from the first charging current to a second charging current. In some implementations, the second charging current can range from about 450 milliamps to about 700 milliamps.

At (210), the method 200 can include determining, via the power management circuit, an expected voltage drop between the external power supply and the electronic device when the electronic device is drawing the second charging current. For instance, the power management circuit can be configured to determine the expected voltage drop based, at least in part, on the second charging current and the resistance of the conductor as determined at (206).

At (212), the method 200 can include monitoring, via the power management circuit, an actual voltage drop between the external power supply and the electronic device when drawing a charging current (e.g., second charging current) from the external power supply. For instance, in some implementations, the power management circuit can be configured to continuously monitor the actual voltage drop. In alternative implementations, the power management circuit can be configured to periodically monitor the actual voltage drop. For instance, the power management circuit can be configured to measure the actual voltage drop after a predetermined amount of time has lapsed since the most-recent measurement of the actual voltage drop.

At (214), the method can include determining, via the power management circuit, whether the actual voltage drop determined at (212) is greater than a threshold voltage drop determined based, at least in part, on the expected voltage drop determined at (210). For instance, the threshold voltage drop can be greater than the expected voltage drop between the external power supply and the electronic device when the electronic device is drawing the second charging current. When the power management circuit determines the actual voltage drop is greater than the threshold voltage drop, the method 200 proceeds to (216). Otherwise, the method 200 reverts to (212).

At (216), the method 200 can include reducing, via the power management circuit, the charging current the electronic device is drawing from the external power supply 110. For instance, the charging current can be reduced until the actual voltage drop between the external power supply and the electronic device is less than the threshold voltage drop. In this manner, the power management circuit of the electronic device can control a charging speed (e.g., charging current) of the electronic device without causing the external power supply to collapse (e.g., trip a circuit breaker). In some implementations, the power management circuit can be configured to reduce the charging current from the second charging current to the first charging current in response to determining the actual voltage drop between the external power supply and the electronic device is greater than the threshold voltage drop.

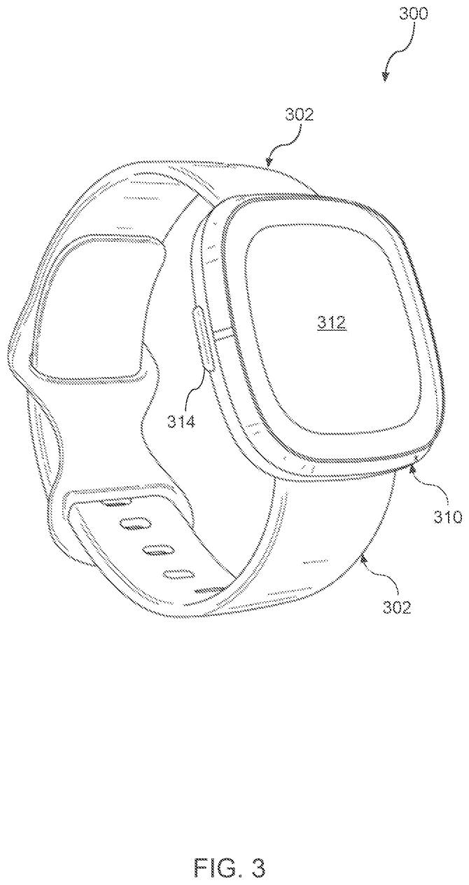

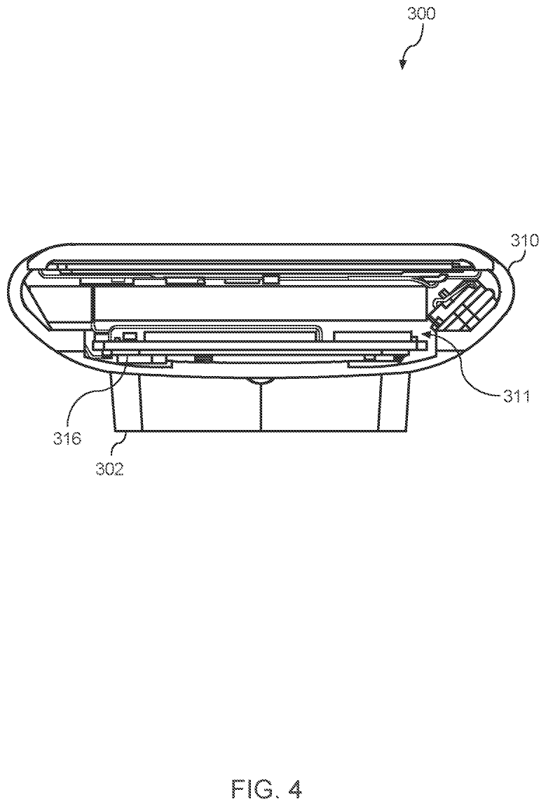

Referring now to FIGS. 3 through 5, a wearable computing device 300 is provided according to some implementations of the present disclosure. It should be understood that the wearable computing device 300 can be the electronic device 100 receiving electrical power from the external power supply 110 as discussed above with reference to FIG. 1. As shown, the wearable computing device 300 can be worn, for instance, on an arm (e.g., wrist) of a user. For instance, the wearable computing device 300 can include a band 302 and a housing 310. In some implementations, the housing 310 can include a conductive material (e.g., metal). In alternative implementations, the housing 310 can include a non-conductive material (e.g., a plastic material, a ceramic material).

The housing 310 can be coupled to the band 302. In this manner, the band 302 can be fastened to the arm of the user to secure the housing 310 to the arm of the user. Furthermore, the housing 310 can define a cavity 311 for one or more electronic components (e.g., disposed on printed circuit boards) of the wearable computing device 300. For instance, the one or more electronic components can include the power management circuit 140 discussed above with reference to FIG. 1.

In some implementations, the wearable computing device 300 can include a display screen 312. The display screen 312 can display content (e.g., time, date, biometrics, etc.) for viewing by the user. In some implementations, the display screen 312 can include an interactive display screen (e.g., touchscreen or touch-free screen). In such implementations, the user can interact with the wearable computing device 300 via the display screen 312 to control operation of the wearable computing device 300.

In some implementations, the wearable computing device 300 can include one or more input devices 314 that can be manipulated (e.g., pressed) by the user to interact with the wearable computing device 300. For instance, the one or more input devices 314 can include a mechanical button that can be manipulated (e.g., pressed) to interact with the wearable computing device 300. In some implementations, the one or more input devices 314 can be manipulated to control operation of a backlight (not shown) associated with the display screen 312. It should be understood that the one or more input devices 314 can be configured to allow the user to interact with the wearable computing device 300 in any suitable manner. For instance, in some implementations, the one or more input devices 314 can be manipulated by the user to navigate through content (e.g., one or more menu screens) displayed on the display screen 312.

The wearable computing device 300 can include an energy storage device 316 positioned within the cavity 311 defined by the housing 310. The energy storage device 316 can be configured to provide direct current power to the one or more electronics of the wearable computing device 300. For instance, in some implementations, the energy storage device 316 can be a rechargeable battery (e.g., lithium ion). It should be understood that the rechargeable battery can have any suitable rated voltage. For instance, in some implementations, the rated voltage of the rechargeable battery can range from about 1.2 Volts to about 3 Volts.

In some implementations, the wearable computing device 300 can include a first electrode 340 and a second electrode 342. It should be understood that, in alternative implementations, the wearable computing device 300 can include more or fewer electrodes. As shown, the first electrode 340 and the second electrode 342 are positioned within respective apertures (e.g., cutouts) defined by the housing 310. Furthermore, since the first electrode 340 and the second electrode 342 are both on a wrist-facing side of the wearable computing device 300, the first electrode 340 and the second electrode 342 can each contact (e.g., touch) the wrist of the user when the user is wearing the wearable computing device 300. In this manner, the first electrode 340 and the second electrode 342 can obtain data indicative of one or more biometrics (e.g., electrodermal activity, electrocardiogram) of the user.

The wearable computing device 300 can include a charging interface 350 configured to couple the wearable computing device 300 to an external power supply (e.g., wall outlet) via a conductor (e.g., charging cable). In some implementations, the charging interface 350 can include a plurality of charging pins positioned on the wrist-facing side of the wearable computing device 300. Each of the charging pins on the wrist-facing side can be electrically coupled to a corresponding contact of the conductor. In alternative implementations, the charging interface 350 can be configured as a charging port. For instance, in some implementations, the charging interface 350 can be configured as a USB charging port.

It should be understood that the wearable computing device 300 can include the power management circuit 140 discussed above with reference to FIG. 1. For instance, the power management circuit 140 of the wearable computing device can be coupled between the charging interface 350 and the energy storage device 316. It should also be understood that the power management circuit 140 can be configured to implement the method 200 discussed above with reference to FIG. 2 to control a charging speed (e.g., charging current) of the wearable computing device 300 to avoid causing the external power supply (e.g., wall outlet) to collapse (e.g., trip the circuit breaker).

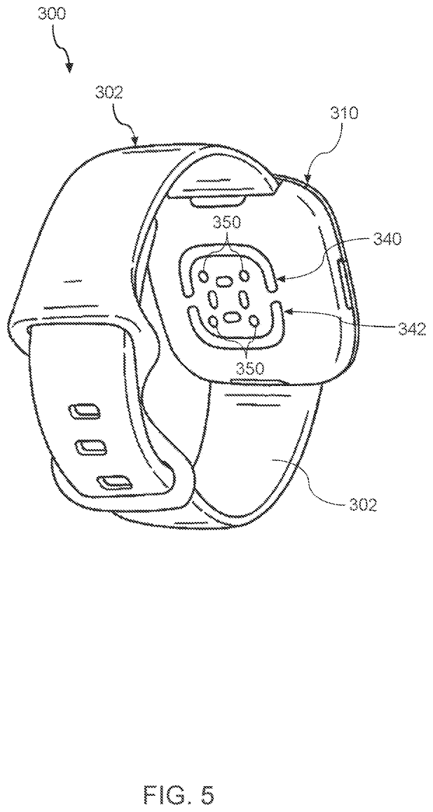

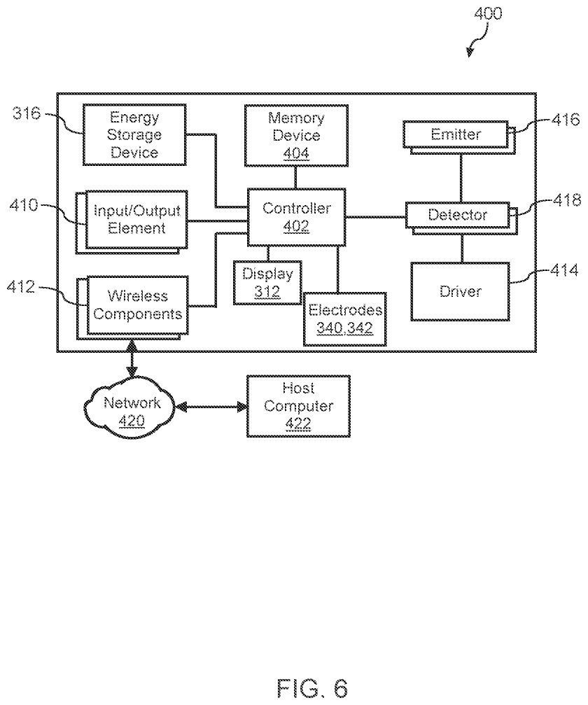

Referring now to FIG. 6, components of an example computing system 400 of the wearable computing device 300 that can be utilized in accordance with various embodiments are illustrated. In particular, as shown, the computing system 400 may also include at least one controller 402 communicatively coupled to the electrodes (e.g., first electrode 340 and second electrode 342) described above with reference to FIG. 5. Moreover, in an embodiment, the controller(s) 202 can be a central processing unit (CPU) or graphics processing unit (GPU) for executing instructions that can be stored in a memory device 404, such as flash memory or DRAM, among other such options. For example, in an embodiment, the memory device 404 may include RAM, ROM, FLASH memory, or other non-transitory digital data storage, and may include a control program comprising sequences of instructions which, when loaded from the memory device 404 and executed using the controller(s) 402, cause the controller(s) 402 to perform the functions that are described herein.

The computing system 400 can include many types of memory, data storage, or computer-readable media, such as data storage for program instructions for execution by the controller or any suitable processor. The same or separate storage can be used for images or data, a removable memory can be available for sharing information with other devices, and any number of communication approaches can be available for sharing with other devices. In addition, as shown, the computing system 400 includes the display 406, which may be a touch screen, organic light emitting diode (OLED), or liquid crystal display (LCD), although devices might convey information via other means, such as through audio speakers, projectors, or casting the display or streaming data to another device, such as a mobile phone, wherein an application on the mobile phone displays the data.

The computing system 400 can include one or more wireless networking components 412 operable to communicate with one or more electronic devices within a communication range of a particular wireless channel. The wireless channel can be any appropriate channel used to enable devices to communicate wirelessly, such as Bluetooth, cellular, NFC, Ultra-Wideband (UWB), or Wi-Fi channels. It should be understood that the computing system 400 can have one or more conventional wired communications connections as known in the art.

The computing system 400 also includes one or more power components 408, such as may include the energy storage device 316 operable to be recharged through conventional plug-in approaches. In some implementations, the computing system 400 can also include at least one additional I/O device 410 able to receive conventional input from a user. This conventional input can include, for example, a push button, touch pad, touch screen, wheel, joystick, keyboard, mouse, keypad, or any other such device or element whereby a user can input a command to the computing system 400. In some implementations, the I/O device(s) 410 can be connected by a wireless infrared or Bluetooth or other link as well in some embodiments. In some implementations, the computing system 400 can include a microphone or other audio capture element that accepts voice or other audio commands. For example, in some implementations, the computing system 400 may not include any buttons at all, but might be controlled only through a combination of visual and audio commands, such that a user can control the wearable computing device 300 without having to be in contact therewith. In some implementations, the I/O device(s) 410 can include one or more of the electrodes (e.g., first electrode 340, second electrode 342), optical sensors, barometric sensors (e.g., altimeter, etc.), and the like.

The computing system 400 can include a driver 414 and at least some combination of one or more emitters 416 and one or more detectors 418 for measuring data for one or more metrics of a human body, such as for a person wearing the wearable computing device 300. In some embodiments, for example, this may involve at least one imaging element, such as one or more cameras that are able to capture images of the surrounding environment and that are able to image a user, people, or objects in the vicinity of the device. The image capture element can include any appropriate technology, such as a CCD image capture element having a sufficient resolution, focal range, and viewable area to capture an image of the user when the user is operating the device. Further image capture elements may also include depth sensors. Methods for capturing images using a camera element with a computing device are well known in the art and will not be discussed herein in detail. It should be understood that image capture can be performed using a single image, multiple images, periodic imaging, continuous image capturing, image streaming, etc. Further, the computing system 400 can include the ability to start and/or stop image capture, such as when receiving a command from a user, application, or other device.

The emitters 416 and the detectors 418 may also be capable of being used, in one example, for obtaining optical photoplethysmogram (PPG) measurements. Some PPG technologies rely on detecting light at a single spatial location, or adding signals taken from two or more spatial locations. Both of these approaches result in a single spatial measurement from which the heart rate (HR) estimate (or other physiological metrics) can be determined. In some embodiments, a PPG device employs a single light source coupled to a single detector (i.e., a single light path). Alternatively, a PPG device may employ multiple light sources coupled to a single detector or multiple detectors (i.e., two or more light paths). In other embodiments, a PPG device employs multiple detectors coupled to a single light source or multiple light sources (i.e., two or more light paths). In some cases, the light source(s) may be configured to emit one or more of green, red, infrared (IR) light, as well as any other suitable wavelengths in the spectrum (such as long IR for metabolic monitoring). For example, a PPG device may employ a single light source and two or more light detectors each configured to detect a specific wavelength or wavelength range. In some cases, each detector is configured to detect a different wavelength or wavelength range from one another. In other cases, two or more detectors are configured to detect the same wavelength or wavelength range. In yet another case, one or more detectors configured to detect a specific wavelength or wavelength range different from one or more other detectors). In embodiments employing multiple light paths, the PPG device may determine an average of the signals resulting from the multiple light paths before determining an HR estimate or other physiological metrics.

Moreover, in an embodiment, the emitters 416 and detectors 418 may be coupled to the controller 402 directly or indirectly using driver circuitry by which the controller 402 may drive the emitters 416 and obtain signals from the detectors 418. The host computer 422 can communicate with the wireless networking components 412 via the one or more networks 420, which may include one or more local area networks, wide area networks, UWB, and/or internetworks using any of terrestrial or satellite links. In some embodiments, the host computer 422 executes control programs and/or application programs that are configured to perform some of the functions described herein.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for controlling charging of a wearable computing device, the method comprising:
determining, via a power management circuit of the wearable computing device, a voltage at a charging interface of the wearable computing device when the wearable computing device is not being charged by an external power supply that is coupled to the charging interface via a conductor;
responsive to determining the voltage, causing, via the power management circuit, the wearable computing device to draw a first charging current from the external power supply;
determining, via the power management circuit, a resistance of the conductor based, at least in part, on the first charging current;
increasing, via the power management circuit, a current draw of the wearable computing device to a second charging current;
determining, via the power management circuit, an expected voltage drop between the external power supply and the wearable computing device when the wearable computing device is drawing the second charging current, the expected voltage drop based, at least in part, on the resistance of the conductor;
determining, via the power management circuit, whether an actual voltage drop between the external power supply and the wearable computing device when the wearable computing device is drawing a charging current is greater than a threshold voltage drop, the threshold voltage drop being greater than the expected voltage drop; and
responsive to determining the actual voltage drop is greater than the threshold voltage drop, reducing, via the power management circuit, the current draw of the wearable computing device.

2. The method of claim 1, wherein the threshold voltage drop corresponds to a voltage drop at which charging the wearable computing device at the second charging current puts the external power supply at risk of collapsing.

3. The method of claim 1, wherein determining whether the actual voltage drop is greater than the threshold voltage drop comprises:
determining, via the power management circuit, the voltage at the charging interface of the wearable computing device after a predetermined amount of time has lapsed; and
comparing, via the power management circuit, the voltage at the charging interface to the threshold voltage drop.

4. The method of claim 1, wherein reducing the current draw of the wearable computing device comprises reducing, via the power management circuit, the current draw of the wearable computing device from the second charging current to the first charging current.

5. The method of claim 1, wherein the voltage at the charging interface of the wearable computing device when the wearable computing device is not being charged by the external power supply corresponds to a voltage at the external power supply.

6. The method of claim 1, wherein the conductor comprises a charging cable.

7. The method of claim 6, wherein the charging cable comprises a universal serial bus (USB) charging cable.

8. The method of claim 6, wherein the resistance of the charging cable is in a range from about 5 ohms to about 20 ohms.

9. The method of claim 1, wherein the threshold voltage drop is greater than the expected voltage drop by at least about 100 millivolts.

10. The method of claim 1, wherein the external power supply comprises a charger configured to be plugged into an alternating current wall outlet.

11. A wearable computing device comprising:
an energy storage device;
a charging interface; and
a power management circuit electrically coupling the charging interface to the energy storage device, the power management circuit configured to:
determine a voltage at the charging interface when the wearable computing device is not being charged by an external power supply to which the wearable computing device is coupled via a conductor coupling the external power supply to the charging interface of the wearable computing device;
cause the wearable computing device to draw a first charging current from the external power supply in response to determining the voltage at the charging interface;
determine a resistance of the conductor based, at least in part, on the first charging current;
increase a current draw of the wearable computing device to a second charging current;
determine an expected voltage drop between the external power supply and the wearable computing device when the wearable computing device is drawing the second charging current based, at least in part, on the resistance of the conductor;
determine whether an actual voltage drop between the external power supply and the wearable computing device when the wearable computing device is drawing a charging current is greater than a threshold voltage drop, the threshold voltage drop being greater than the expected voltage drop; and
reduce the current draw of the wearable computing device in response to determining the actual voltage drop is greater than the threshold voltage drop.

12. The wearable computing device of claim 11, wherein the energy storage device comprises a rechargeable battery.

13. The wearable computing device of claim 11, wherein to determine whether the actual voltage drop is greater than the threshold voltage drop, the power management circuit is configured to:
determine the voltage at the charging interface of the wearable computing device after a predetermined amount of time has lapsed; and
compare the voltage at the charging interface to the threshold voltage drop.

14. The wearable computing device of claim 11, wherein the voltage at the charging interface when the wearable computing device is not being charged by the external power supply corresponds to a voltage at the external power supply.

15. The wearable computing device of claim 11, wherein the charging interface comprises a plurality of charging pins, each of the charging pins couplable to a corresponding contact of the conductor.

16. The wearable computing device of claim 11, wherein the first charging current is in a range from about 50 milliamps (mA) to about 200 mA.

17. The wearable computing device of claim 11, wherein the second charging current is in a range from about 450 milliamps (mA) to about 600 mA.

18. The wearable computing device of claim 11, wherein the threshold voltage drop corresponds to a voltage drop at which charging the wearable computing device at the second charging current puts the external power supply at risk of collapsing.

19. The wearable computing device of claim 11, wherein the power management circuit is configured to reduce the current draw of the wearable computing device to the first charging current in response to determining the actual voltage drop is greater than the threshold voltage drop.

20. The wearable computing device of claim 11, further comprising:
a display configured to display content for viewing by a user.
